(19) United States
(12) Patent Application Publication
(10) Pub. No.: US 2026/0313038 A1
(43) Pub. Date: Oct. 8, 2026

(54) METHOD, APPARATUS, DEVICE, MEDIUM AND PRODUCT FOR PROCESSING LIVE STREAMING

(71) Applicant: Bytedance Technology Ltd., Grand Cayman (KY)

(72) Inventor: Yuxuan LIU, Beijing (CN)

(21) Appl. No.: 19/638,868

(22) Filed: Apr. 3, 2026

(30) Foreign Application Priority Data
Apr. 3, 2025 (CN) 202510421446.X

(51) Int. Cl. H04L 67/55

(52) U.S. Cl. CPC H04L 67/55

(57) ABSTRACT

Embodiments of the present disclosure relate to a method, an apparatus, a device, a medium, and a product for processing live streaming. The method includes determining a target end time of a periodic live streaming in response to detecting a first live streaming announcement for the periodic live streaming. The method further includes determining whether the periodic live streaming exists in response to the arrival of the target end time. The method further includes determining a next start time of the periodic live streaming in response to determining absence of the periodic live streaming. The method further includes generating a second live streaming announcement for the periodic live streaming based on the next start time.

### CROSS-REFERENCE TO RELATED APPLICATION(S)

This application claims priority to Chinese Application No. 202510421446.X filed on Apr. 3, 2025, the disclosure of which is incorporated herein by reference in its entity.

### FIELD

Embodiments of the present disclosure generally relate to the field of live streaming application technologies, and in particular, to a method, an apparatus, a device, a medium, and a product for processing live streaming.

### BACKGROUND

With the rapid development of the live streaming industry, live streaming announcements have become an important tool for platforms and live streamers to interact with audiences. By publishing announcements, live streamers may not only inform audiences of upcoming live streaming content and time in advance, but also effectively improve audiences' sense of participation and live streaming viewing rates. With the popularization of smart phones and mobile Internet, users may obtain the latest live streaming information anytime and anywhere, which further promotes the popularization of live streaming content and the development of platforms.

In addition, the development of live streaming platforms also presents a trend of globalization.

### SUMMARY

Embodiments of the present disclosure provide a method, an apparatus, a device, a medium, and a product for processing live streaming.

According to a first aspect of the present disclosure, there is provided a method for processing live streaming. The method includes determining a target end time of a periodic live streaming in response to detecting a first live streaming announcement for the periodic live streaming. The method further includes determining whether the periodic live streaming exists in response to the arrival of the target end time. The method further includes determining a next start time of the periodic live streaming in response to determining absence of the periodic live streaming. The method further includes generating a second live streaming announcement for the periodic live streaming based on the next start time.

According to a second aspect of the present disclosure, there is provided an apparatus for processing live streaming. The apparatus includes a target end time determination module configured to determine a target end time of a periodic live streaming in response to detecting a first live streaming announcement for the periodic live streaming; a periodic live streaming existence detection module configured to determine whether the periodic live streaming exists in response to the arrival of the target end time; a start time calculation module configured to determine a next start time of the periodic live streaming in response to determining absence of the periodic live streaming; and a live streaming announcement generation module configured to generate a second live streaming announcement for the periodic live streaming based on the next start time.

In a third aspect of the present disclosure, there is provided an electronic device including at least one processor; and a storage apparatus for storing at least one program, the at least one program, when executed by the at least one processor, causes the at least one processor to implement the method according to the first aspect of the present disclosure.

In a fourth aspect of the present disclosure, there is provided a computer-readable storage medium having a computer program stored thereon, which, when executed by a processor, implements the method according to the first aspect of the present disclosure.

In a fifth aspect of the present disclosure, there is provided a computer program product. The computer program product includes a computer program that, when executed by a processor, implements the method according to the first aspect of the present disclosure.

It should be understood that the content described in this Summary section is neither intended to identify key or important features of the embodiments of the present disclosure, nor is it intended to limit the scope of the present disclosure. Other features of the present disclosure will be readily envisaged through the following description.

### BRIEF DESCRIPTION OF THE DRAWINGS

The above and other objects, features and advantages of the present disclosure will become more apparent by describing the exemplary embodiments of the present disclosure in more detail with reference to the drawings, in which the same reference numerals generally represent the same components in the exemplary embodiments of the present disclosure.

FIG. 1 is a schematic diagram of an example environment in which the devices and/or methods of some embodiments of the present disclosure may be implemented;

FIG. 2 is a schematic diagram of an example method for processing live streaming according to some embodiments of the present disclosure;

FIG. 3 is a schematic diagram of an example method for a simplified lifecycle process of a live streaming announcement according to some embodiments of the present disclosure;

FIG. 4 is a schematic diagram of an example method for an overall process of distributed periodic live streaming announcement according to some embodiments of the present disclosure;

FIG. 5 is a schematic diagram of an example method for achieving global cross-time zone consistency according to some embodiments of the present disclosure;

FIG. 6 is a schematic diagram of repeated date selection in a live streaming announcement according to some embodiments of the present disclosure;

FIG. 7 is a schematic diagram of next step setting in a live streaming announcement according to some embodiments of the present disclosure;

FIG. 8 is a schematic diagram of a live streaming announcement page according to some embodiments of the present disclosure;

FIG. 9 is a schematic block diagram of an apparatus for processing live streaming according to some embodiments of the present disclosure; and

FIG. 10 is a schematic block diagram of an example device suitable for implementing multiple embodiments of the present disclosure.

### DETAILED DESCRIPTION OF EMBODIMENTS

It may be understood that the data involved in the technical solution (including but not limited to the data itself, acquisition or use of the data) shall comply with requirements of corresponding laws, regulations, and related provisions.

It may be understood that before using the technical solutions disclosed in the embodiments of the present disclosure, the user shall be informed of the type, range of use, use scenarios, etc. of personal information involved in the present disclosure and the authorization of the user shall be obtained in an appropriate manner in accordance with relevant laws and regulations.

For example, when receiving an active request from a user, a prompt message is sent to the user to clearly inform the user that the requested operation will require access to and use of personal information of the user. In this way, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to receiving the active request from the user, the prompt message may be sent to the user in the form of, for example, a pop-up window, in which the prompt message may be presented in text. In addition, the pop-up window may also include a selection control for the user to select whether to "agree" or "disagree" to provide the personal information to the electronic device.

It may be understood that the above process of notifying and obtaining user authorization is only illustrative and does not limit the implementations of the present disclosure, and other methods that satisfy relevant laws and regulations may also be applied to the implementations of the present disclosure.

Hereinafter, embodiments of the present disclosure will be described in more detail with reference to the drawings. Although some embodiments of the present disclosure are shown in the drawings, it should be understood that the present disclosure may be implemented in various forms and should not be construed as being limited to the embodiments set forth herein. Instead, these embodiments are provided for a more thorough and complete understanding of the present disclosure. It should be understood that the drawings and embodiments of the present disclosure are only used for illustrative purposes, and are not used to limit the protection scope of the present disclosure.

In the description of the embodiments of the present disclosure, the term "include/comprise" and similar terms should be understood as open-ended inclusions, that is, "include/comprise but not limited to". The term "based on" should be understood as "at least partially based on". The term "one embodiment" or "the embodiment" should be understood as "at least one embodiment". The terms "first", "second", etc. may refer to different or same objects. Other definitions, either explicit or implicit, may also be included below.

With the diversity of audience groups and their distribution in different regions, it is necessary to accurately push live streaming announcements to global audiences, and ensure that audiences in each time zone may receive accurate live streaming reminders in time, which has become an important issue for platforms to improve user experience. The live streaming announcement is not only a bridge of communication between the live streaming platform and audiences, but also a key tool for the platform to spread content.

As mentioned above, with the rapid development of mobile Internet and live streaming technologies, the live streaming announcement function plays an important role in improving user experience and engagement. In the existing process of processing live streaming periodic tasks, scheduling of the live streaming periodic tasks is usually automatically managed by a system. When the system starts, a predetermined daemon process automatically starts. This daemon process runs continuously in the background and is responsible for reading and parsing task rules in a file for periodic live streaming. The time is checked at a certain frequency (usually every minute) to determine whether a task execution condition is satisfied. When the time matches, the daemon process creates a child process to execute a corresponding task command. Existing periodic tasks are basically based on timed tasks, in which data that needs to be processed is obtained periodically and a certain piece of batch processing logic is triggered. For example, for a related implementation of periodic live streaming announcement, the database is scanned periodically in batches to check whether the periodic announcement configuration in the database has been executable and whether an announcement for a next period needs to be generated (if yes, it is generated).

However, there are many problems with this traditional approach. For example, when a downstream service is invoked, there is a centralized invocation, generating traffic spikes. In the method of performing periodic processing on timed tasks, a batch of data is acquired and generated in a centralized manner. A downstream service will have a surge in request pressure. In addition, the impact area of centralized batch processing is large. A timed task is generally processed by an instance in a cluster in a batch and centralized logic. If there is a problem with the instance, this task may fail, and all tasks to be executed in this batch will fail, resulting in a large impact area. In addition, the pressure on a database is increased, and a large amount of data needs to be scanned every time. An existing timed task needs to periodically scan data that needs to be processed in the database at intervals, which will undoubtedly increase the pressure on database reading. In addition, the execution time of each unit task may be delayed. The time required to process each unit task is different, and it is only possible to wait for each timed task to be scanned before performing batch and centralized processing. For some unit tasks, there may be a delay between an actual execution time and a really desired execution time.

To this end, embodiments of the present disclosure provide a method for processing live streaming. In this method, if a computing device detects a first live streaming announcement for a periodic live streaming, it determines a target end time of the periodic live streaming. Then, the computing device further determines whether the periodic live streaming exists when the target end time arrives. If the computing device determines absence of the periodic live streaming, it determines a next start time of the periodic live streaming. Finally, the computing device generates a second live streaming announcement for the periodic live streaming based on the next start time. By means of this method, each live streaming announcement may be processed individually, execution delay is reduced, and traffic surges during centralized processing of live streaming announcements are also avoided, thereby improving the efficiency of users in obtaining live streaming information and improving user experience.

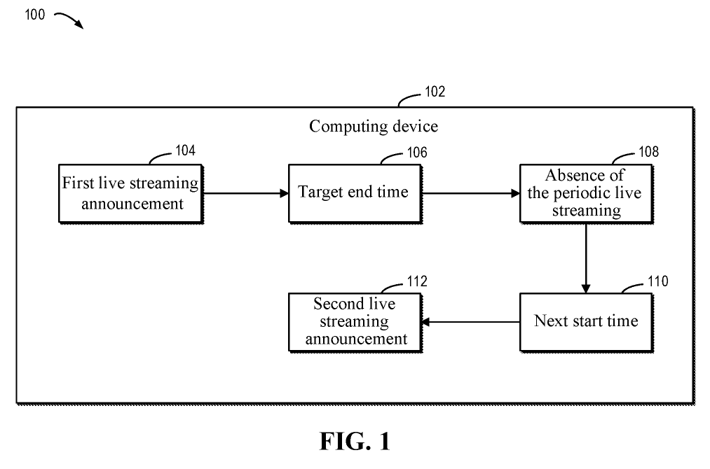

Hereinafter, the embodiments of the present disclosure will be described in more detail with reference to the drawings. FIG. 1 shows an example environment in which the devices and/or methods of the embodiments of the present disclosure may be implemented. In environment 100, a computing device 102 may manage and control processing of live streaming announcements.

Examples of the computing device 102 include, but are not limited to, a personal computer, a server computer, a handheld or laptop device, a mobile device (such as a mobile phone, a personal digital assistant (PDA), a media player, etc.), a multi-processor system, a consumer electronic product, a minicomputer, a mainframe computer, a distributed computing environment including any of the above systems or devices, etc.

As shown in FIG. 1, if a user wants to live stream periodically, he/she may set up a live streaming announcement for periodic live streaming. Other users are notified of watching his/her live streaming through this live streaming announcement. At this time, the user may use a client device to send a request to create a first live streaming announcement. The client device may also be referred to as a first device. Then, after acquiring the request to create the live streaming announcement, a management device may determine a start time of the first live streaming announcement 104 of the periodic live streaming according to current time and time information in the first live streaming announcement. Then, such information of the first live streaming announcement 104 is stored in a database for storing announcement information for live streaming. Additionally, the management device may be the computing device 102.

The computing device 102 may determine a periodic live streaming announcement by detecting information of the database. For example, after detecting that a the database has changed, it is determined whether the information includes periodic field information, thereby detecting a live streaming announcement for periodic live streaming in the database. For example, the computing device 102 may detect whether the first live streaming announcement 104 for the periodic live streaming exists by acquiring the information of the database for storing the announcement information for the periodic live streaming.

For example, a live streamer creates a periodic live streaming announcement through a management interface of the platform. If the periodic live streaming set by the live streamer starts at 8:00 pm every day and lasts for one hour, the live streamer will send a request for creating the announcement. After receiving the request from the live streamer, the management device determines the start time of the live streaming announcement based on the current creation time, and then stores the announcement data in the database. The information is recorded in a table in the database. In addition, the computing device 102 is configured with a function of detecting the database. The database records all changes in the database, including the creation of the periodic live streaming announcement. Whenever data is changed or added, and the computing device 102 detects and acquires the information. When a new record of periodic live streaming announcement is added to the database, and the computing device 102 may detect the announcement including the periodic field. At this time, the computing device 102 may determine whether a periodic live streaming announcement exists based on the field information.

After determining that the first live streaming announcement exists, the computing device 102 generates a message based on acquired information related to the first live streaming announcement and puts the message into a delay message queue to delay processing of the message to a target end time 106. Additionally, a first time before the target end time 106 arrives, the first device is reminded to start the live streaming; or a second time before the target end time arrives, the first device is reminded to start the live streaming, where the first time and the second time are different. For example, if the live streaming start time is 8:00 pm, the first time is ten minutes, and the second time is twenty minutes, the computing device 102 reminds the first device at 7:50 pm when using the first time reminder, or the computing device 102 reminds the first device at 7:40 pm when using the second time reminder.

In some embodiments, if the first live streaming announcement includes a live streaming start time and a live streaming duration, the computing device 102 may calculate the target end time 106 according to the obtained start time of the first live streaming announcement and the duration of the periodic live streaming. In some other embodiments, if the first live streaming announcement includes the live streaming start time and a predetermined live streaming period, the target end time 106 of the live streaming may be determined according to the start time and the period. The above examples are only used to describe the present disclosure, but not to specifically limit the present disclosure.

After the target end time arrives, the computing device detects a live streaming state of the first live streaming of the current periodic live streaming at the time of the target end time. If the state of the first live streaming at this time is a closed state, that is, there is no periodic live streaming 108 or the live streaming has been completed, the computing device calculates the next start time 110 according to the obtained time information of the periodic live streaming. After calculating the next start time 110 of the next announcement, the computing device 102 generates a second live streaming announcement 112 for the periodic live streaming, and writes the announcement of the second live streaming into the database. The computing device 102 acquires information for the second live streaming announcement 112 in the database to detect the second live streaming announcement and waits for the execution of the announcement.

In addition, in a traditional solution, a periodic expression cannot be processed across time zones. For example, an expression such as "30 15 * * 1,3" means that live streaming starts at 15:30 on every Monday and Wednesday. This periodic expression may only express periodic execution time and cannot be processed across time zones. To further solve the above problem, in the present disclosure, after a live streaming announcement is sent out and a subscription from a user is received, the computing device determines a first time zone where the first device is located. When a live streaming periodic announcement is created on a live streamer side, the computing device may record a time zone of the live streamer, and calculate standard time (utc+0), that is, a reference live streaming time of the periodic live streaming in a standard time zone, based on the time zone of the live streamer and time of a periodic expression (for example, a cron expression). Then, a time zone where the user is located is acquired, and then a time when the live streaming announcement should be displayed in the time zone of the audience is calculated according to the calculated standard time and the time zone where the user is located. For example, if a live streamer wants to live stream at 15:30 on every Monday and Wednesday in the time zone where he/she is located, an expression form in the cron expression is: "30 15 * * 1,3". At the same time, it is acquired that the time zone where the live streamer is located is (utc+8), then the calculated time for the live streaming to start in the standard time zone at this time is 7:50. If the acquired time zone of the user side is (utc+1), the start time displayed in the announcement of the periodic live streaming on the user side should be 8:50.

By means of this method, through distributed processing of periodic tasks, the pressure on the database and the invocation pressure caused by the processing of periodic tasks are avoided, and a large-scale impact caused by the failure of task execution is also avoided. At the same time, further, a combination of a periodic time expression and a standard time zone is used to achieve accuracy of global cross-time zone announcements, thereby ensuring the accuracy and efficiency of periodic task announcements, enhancing the experience of live streaming announcements, optimizing the management of system resources, and improving user experience.

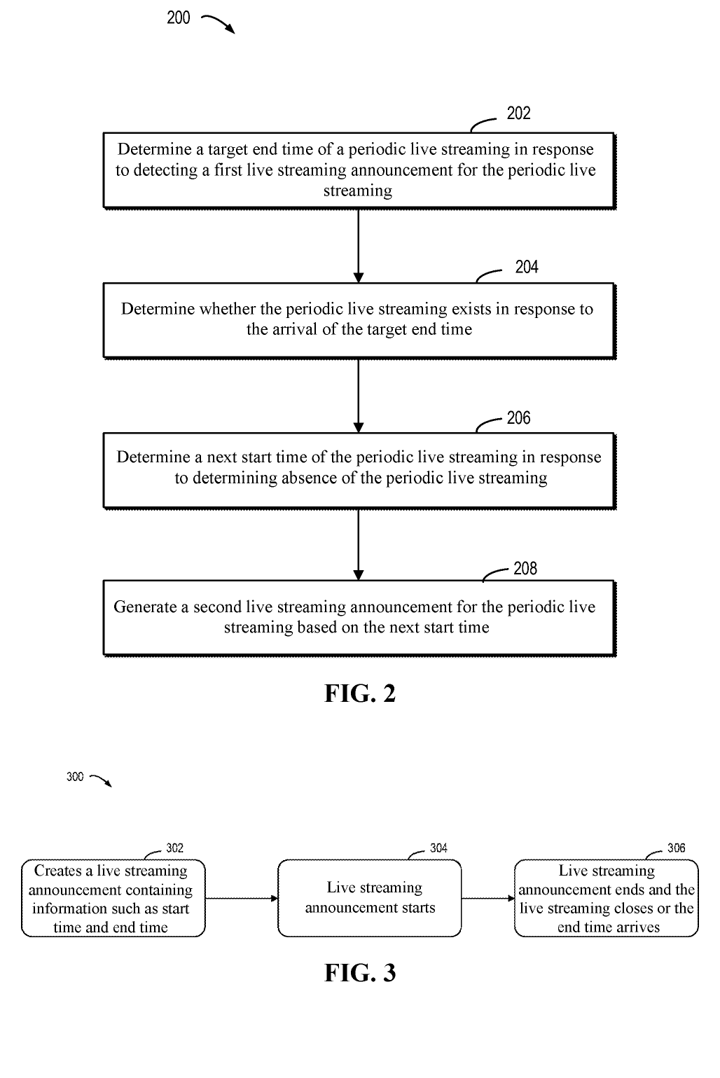

A schematic diagram of an example environment in which the devices and/or methods of some embodiments of the present disclosure may be implemented is described above with reference to FIG. 1, and a schematic diagram of an example method for processing live streaming according to some embodiments of the present disclosure is described below with reference to FIG. 2. The method in FIG. 2 may be performed by the computing device 102 in FIG. 1 or any suitable computing device.

As shown in FIG. 2, in the example method 200, at a block 202, the computing device 102 determines a target end time of a periodic live streaming, that is, an expected end time of the live streaming within a period, in response to detecting a first live streaming announcement for the periodic live streaming. The obtained target end time of the periodic live streaming makes it possible to determine a live streaming existence state of the periodic live streaming at the target end time, thereby determining a start announcement time of a next live streaming.

The computing device 102 determines, according to detected changes in a database, whether a periodic live streaming task is generated in the database or whether a periodic live streaming task has changed. When it is detected that the periodic field information in the database has changed, the computing device 102 identifies the change and extracts related live streaming information, and acquires the first live streaming announcement according to the periodic live streaming task information in the database. Then, the target end time of the periodic live streaming is determined according to the first live streaming announcement.

For example, a live streaming start time is calculated when the first live streaming announcement is stored, and then the live streaming start time is stored in the database. In one example, the live streaming start time of the periodic live streaming and a duration of the periodic live streaming are calculated to obtain the target end time of the periodic live streaming.

At a block 204, the computing device 102 determines whether the periodic live streaming exists in response to the arrival of the target end time. After determining the target end time, the computing device 102 puts a message generated based on the first live streaming announcement into a delay message queue to wait for processing. Through the delay queue, the target end time is waited for to perform a next operation. At this time, the computing device 102 compare the acquired current time with the calculated target end time of the periodic live streaming. When the current time acquired by the computing device is consistent with the calculated target end time of the periodic live streaming, a current live streaming state of the periodic live streaming is determined. If the current live streaming state is an active broadcast state, the computing device 102 does not trigger the next operation, but uses a delay detection mechanism. The computing device 102 waits for a predetermined duration, for example, one minute, and continues to determine the live streaming state. If it is still in the active broadcast state, this process is continued to be repeated at intervals of the predetermined duration until it is detected that the live streaming has been closed, and the next action is performed.

At a block 206, after determining that there is currently no periodic live streaming, the computing device 102 calculates a start time of a next live streaming based on a periodic rule. At this time, the start time of the next periodic live streaming is also acquired according to a periodic expression (for example, a cron expression) of the live streaming announcement. For example, the computing device 102 parses the periodic expression, for example, (0 20 * * *) means that live streaming starts at 20:00 every day. Through calculation, the start time of the next live streaming is acquired. The computing device 102 stores the calculated start time of the next live streaming into the database and prepares to generate a new live streaming announcement.

At a block 208, the computing device 102 generates a corresponding second live streaming announcement based on the acquired start time of the next periodic live streaming. The computing device 102 may store the second live streaming announcement into the database and schedule it using the delay message queue. For example, after calculating the start time of the next live streaming according to the first live streaming announcement and the current time to generate the second live streaming announcement, the computing device 102 stores the second live streaming announcement including the start time into the database for subsequent processing. After detecting the second live streaming announcement, the computing device 102 pushes the live streaming announcement task to the delay message queue and sets a trigger delay mechanism to ensure that the announcement is executed at a correct time point.

Additionally, after the user subscribes to the live streaming announcement sent by the live streamer, the computing device calculates the reference live streaming time of the periodic task in the standard time zone according to the first time zone where the first device of the live streamer is located, and then calculates the live streaming announcement time to be presented in the second time zone where the user is located based on the reference live streaming time in the standard time zone and the second time zone where the user is located. For example, when a device of a live streamer subscribed by the user is in the first time zone (for example, Eastern Standard Time (EST) of the United States), the computing device converts the live streaming announcement into the standard time zone (Coordinated Universal Time (UTC)) based on the first time zone. Then, the computing device calculates the local live streaming announcement time of the user in combination with the second time zone (such as China Beijing Time (CST)) of the user. When the time zone where the live streamer is located is EST (UTC-5), the live streaming announcement time is 20:00 EST on February 20th, and the time zone where the user is located is CST (UTC+8), the converted presentation live streaming time of the user is 9:00 CST on February 21st.

In some embodiments, after the target end time of the periodic live streaming is acquired, assuming that this time is 3:00 pm every day, the computing device determines the current live streaming state of the periodic live streaming at 3:00 pm. If the current live streaming is still in progress, the live streaming state is determined after one minute of delay. If the live streaming has not ended, this operation is repeated until the live streaming ends and the user who subscribes to the live streaming announcement is pushed the next live streaming announcement. If the current live streaming state of the periodic live streaming is determined to be the closed state at the target end time, the computing device generates the announcement information of the next live streaming and pushes the announcement information of the next live streaming to all subscribed users.

In some embodiments, in order to improve user experience, a reminder is actively sent to a subscribed user. The computing device 102 reminds a second device that live streaming is about to start a first time before the live streaming start time arrives, and/or the computing device 102 reminds the second device that the live streaming is about to start a second time before the live streaming start time arrives, where the first time and the second time are different. For example, 24 hours before the live streaming starts, the computing device reminds the user by default that the live streaming is about to start. Before this, the user may customize the reminder time, such as ten minutes or five minutes before the live streaming starts. The computing device may also push messages to the user in various ways, such as a push notification from a mobile client, an email reminder or an in-app reminder, etc.

By means of this method, the implementation of the live streaming periodic task uses a delay queue and detects changes in the database to implement distributed processing, and uses a calculation of a time expression and a standard time zone to obtain an accurate live streaming time that should be presented on the user side, thereby implementing automated management of periodic live streaming. It may not only ensure the accuracy of live streaming announcements, but also optimize user experience in combination with time zone differences, and improve user engagement through a multiple reminder mechanism, thereby improving the intelligence level and user satisfaction of live streaming platforms.

A schematic diagram of an example method for processing live streaming according to some embodiments of the present disclosure is described above with reference to FIG. 2, and a schematic diagram of an example method for a simplified lifecycle process of a live streaming announcement according to some embodiments of the present disclosure is described below with reference to FIG. 3. The example method 300 in FIG. 3 may be processed by the computing device 102 in FIG. 1 or any suitable computing device.

At a block 302, the computing device 102 may create a live streaming announcement containing information such as a live streaming start time (starttime) and a live streaming end time (endtime).

The computing device stores the live streaming announcement into the database and detects task changes. The computing device also pushes the task to a message queue, and uses a delay task scheduling mechanism to ensure that the announcement message may be pushed at an appropriate time point.

At a block 304, when the live streaming time is approaching, the computing device 102 actively pushes a live streaming reminder message to remind the user that the live streaming is about to start. At this time, the computing device pushes announcements at different time points. For example, a default first time reminder is 24 hours before the live streaming starts, and the computing device sends a notification that the live streaming is about to start to the subscribed user. The user may also manually set a reminder time, such as ten minutes or five minutes before the live streaming starts, and the computing device pushes an additional reminder according to user preferences.

At a block 306, the live streaming announcement ends and the live streaming closes, or the end time arrives. When the end time arrives, the computing device 102 detects whether the live streaming is still in progress. If the live streaming is still in the active broadcast state, the computing device uses the delay detection mechanism to detect every minute until the live streaming really ends. If the live streaming has been closed when the end time arrives, the computing device directly updates the database and marks the live streaming announcement state as completed.

Therefore, by means of this method, through this set of processes, the automated management of periodic live streaming runs efficiently, providing a smoother and smarter live streaming experience for both live streamers and audiences.

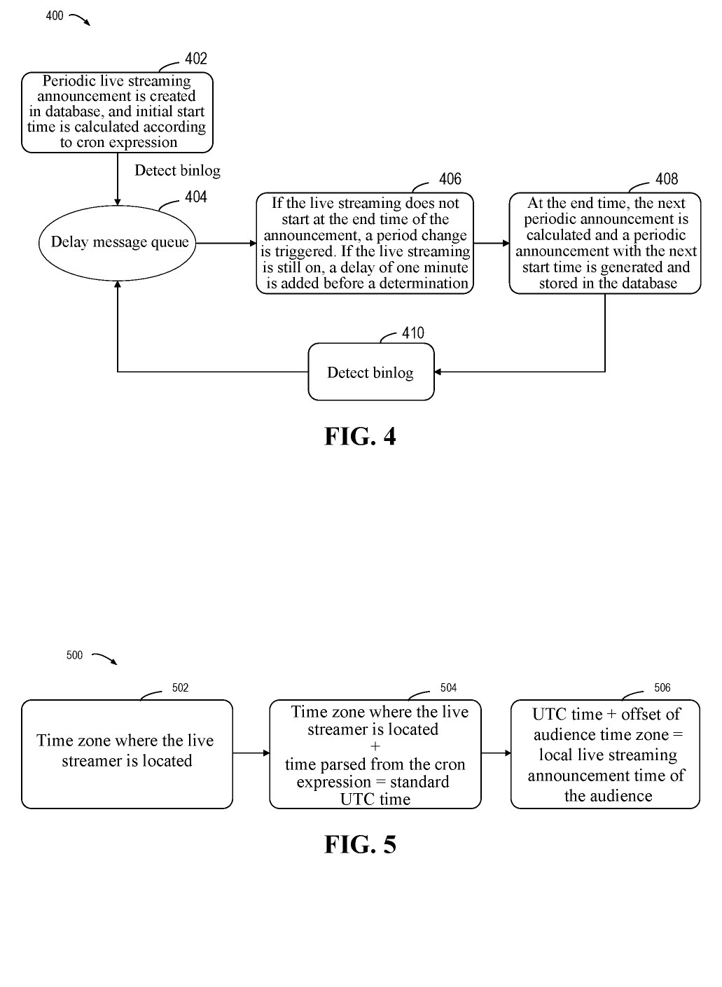

A schematic diagram of an example method for a simplified lifecycle process of a live streaming announcement according to some embodiments of the present disclosure is described above with reference to FIG. 3, and a schematic diagram of an example process of an overall process of distributed periodic live streaming announcement according to some embodiments of the present disclosure is described below with reference to FIG. 4. The example process 400 in FIG. 4 may be performed by the computing device 102 shown in FIG. 1 or any suitable device.

In the example process 400, the overall process of distributed periodic live streaming announcement is described. At a block 402, a periodic live streaming announcement is created in a database, and then an initial start time start_time is calculated according to a cron expression. Then, the periodic live streaming announcement including the start time is stored in the database. By detecting the change in the database, a message for executing a scheduled task at an end time of the announcement is generated and put into a delay message queue 404, for example, the scheduled task is a task in a block 408.

At a block 406, if the live streaming does not start at the end time of the announcement, a period change is triggered. If the periodic live streaming is still in an active broadcast state, it waits for one minute and then determines again, until a determination result is that the live streaming ends.

At the block 408, when it is determined that the current live streaming ends, a next period is processed, a start time of a next live streaming period is calculated, and a periodic live streaming announcement having the start time of the next live streaming period is written into the database. Since the next periodic live streaming announcement is written into the database, the database changes at this time. At a block 410, the newly written next periodic live streaming announcement may be acquired from the database, and key information therein may be further parsed, such as the start time of the next periodic live streaming announcement. On this basis, a message for executing a corresponding task at an end time of the new announcement is generated and put into the delay message queue 404. Periodic cycle is implemented. An example of achieving global cross-time zone consistency according to the present disclosure is described below with reference to FIG. 5. In the example process 500, a time zone time_zone where a live streamer is located is first acquired at a block 502, and then at a block 504, the computing device 102 sums time parsed from the cron expression and the time zone time_zone where the live streamer is located to obtain UTC time in the standard time zone. Finally, the computing device acquires the time zone where a second device of a subscribed audience side is located, and sums the standard UTC time and an offset of the audience time zone at a block 506 to obtain local live streaming announcement time of the audience.

By means of this method, the cron expression and the time zone field are used to achieve global cross-time zone consistency of periodic announcements, thereby ensuring that the live streaming announcement information pushed to users subscribing to live streaming in different time zones is accurate, effectively improving the intelligence level of the live streaming platform, and enhancing the experience of live streamers and users.

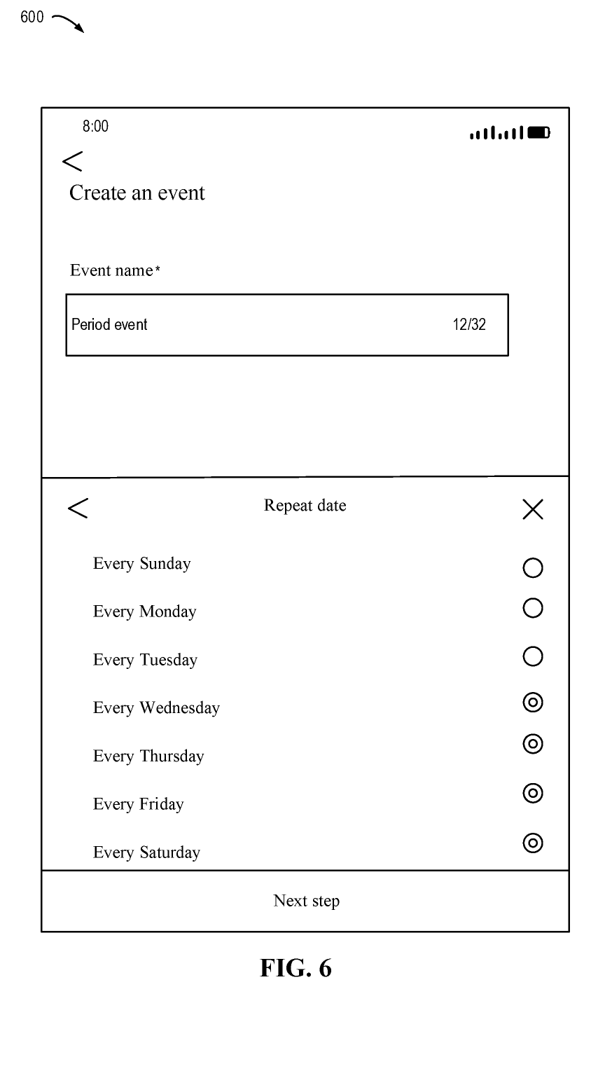

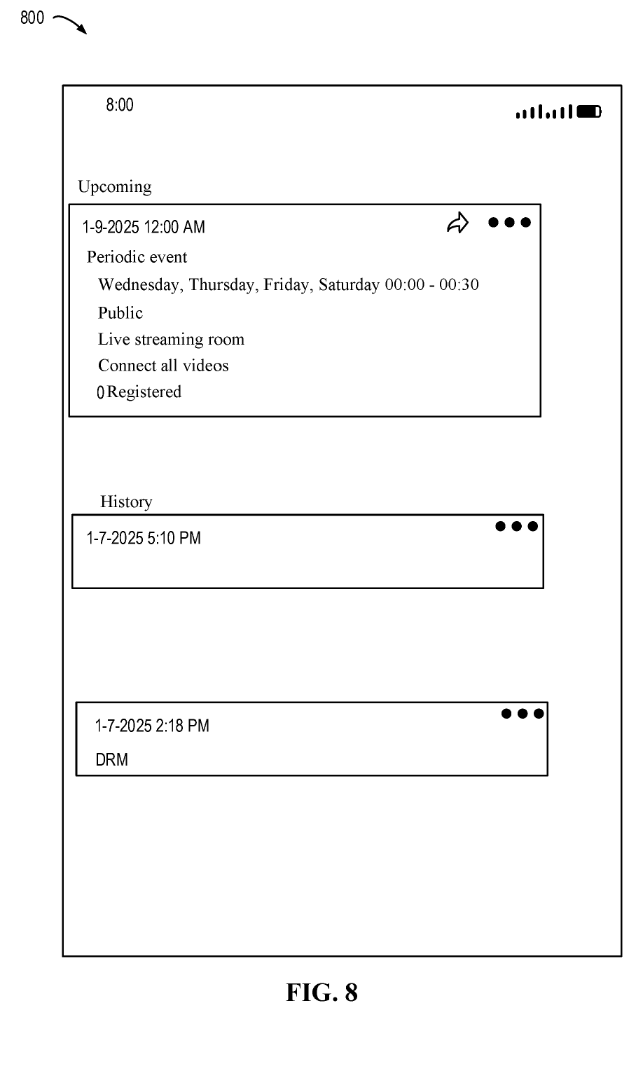

An example of setting a live streaming announcement for periodic live streaming is described below with reference to FIGS. 6 and 8. Among them, FIG. 6 illustrates a schematic diagram of repeated date selection in a live streaming announcement according to some embodiments of the present disclosure. In the example 600, a process of a live streamer creating a periodic live streaming task in a first device is described. The live streamer first sets a title of the live streaming on a task creation page, and then selects days that need to be repeated every week under a repeated option, and tick the box to indicate the live streaming days that need live streaming every week.

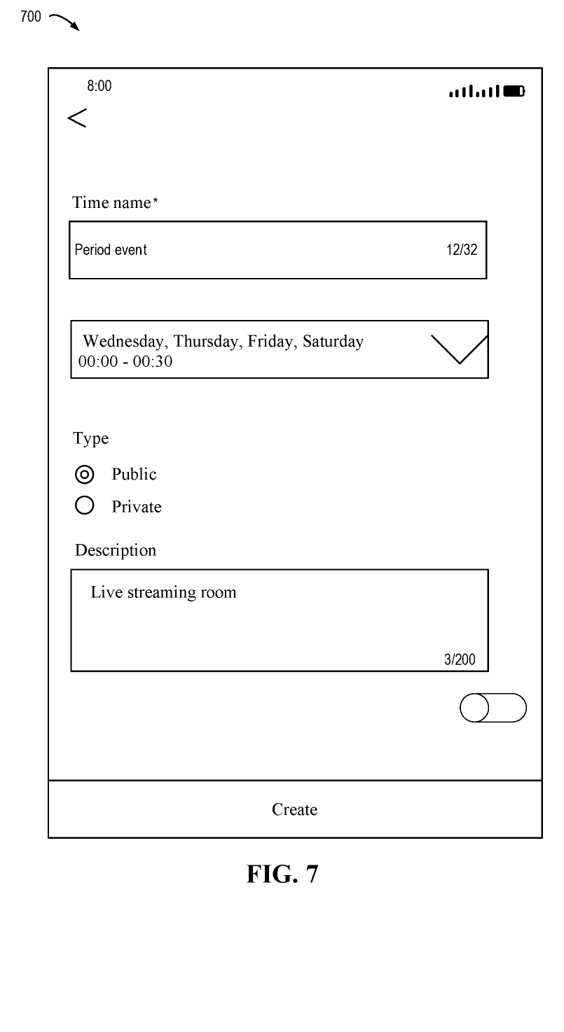

FIG. 7 illustrates a schematic diagram of next step settings in a live streaming announcement according to some embodiments of the present disclosure. In the example 700, a schematic diagram of settings in a live streaming event created by a live streamer is described. The live streamer selects a live streaming day, live streaming time and live streaming permission on a second page. The live streaming permission is divided into public and private. Selecting public means that each user may view the live streaming room, and selecting private means that only a user group specified by the live streamer may watch the live streaming. Then, the live streamer continues to add a live streaming description to this live streaming below to remind the user of the general content of the live streaming. At the end, there is an audience control option to control whether the live streaming may be viewed by minors.

FIG. 8 illustrates a schematic diagram of a live streaming announcement page according to some embodiments of the present disclosure. In the example 800, a schematic diagram of the live streaming announcement page is described. The live streaming announcement page includes an upcoming live streaming start time and some information about this live streaming, including live streaming time, a live streaming range, the number of subscribers, etc., and also includes historical live streaming time, etc.

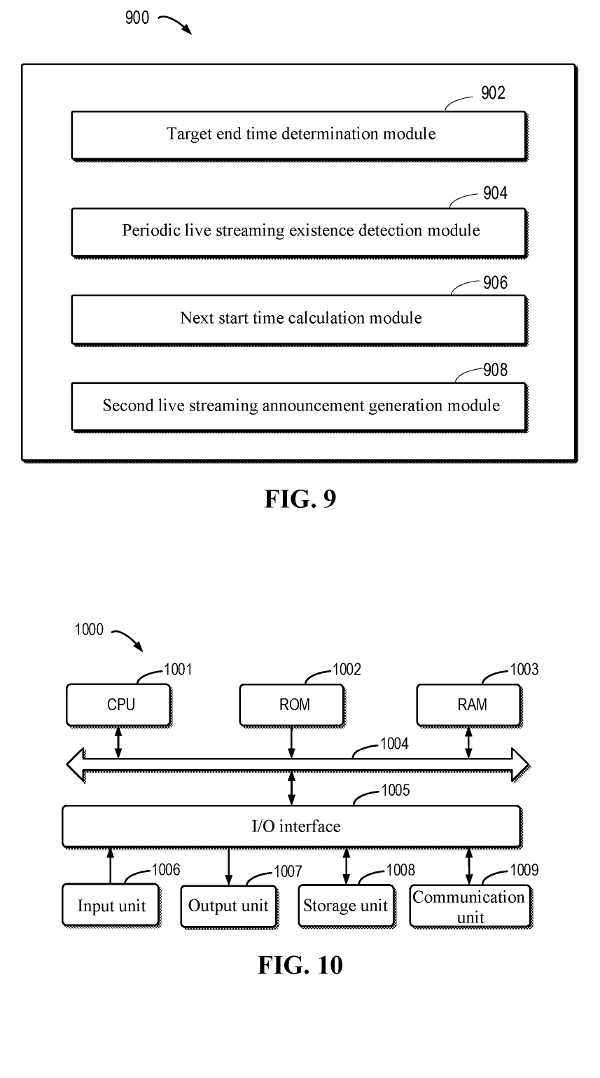

FIG. 9 illustrates a schematic block diagram of an apparatus for processing live streaming according to some embodiments of the present disclosure. As shown in FIG. 9, the apparatus 900 includes a target end time determination module 902 configured to determine a target end time of a periodic live streaming in response to detecting a first live streaming announcement for the periodic live streaming; a periodic live streaming existence detection module 904 configured to determine whether the periodic live streaming exists in response to the arrival of the target end time; a start time calculation module 906 configured to determine a next start time of the periodic live streaming in response to determining absence of the periodic live streaming; and a live streaming announcement generation module 908 configured to generate a second live streaming announcement for the periodic live streaming based on the next start time.

In some embodiments, the target end time determination module 902 includes: a first live streaming announcement time parsing module configured to determine a start time of the first live streaming announcement and a duration of the periodic live streaming based on the first live streaming announcement; and a target end time calculation module configured to determine the target end time based on the start time and the duration.

In some embodiments, the start time calculation module 906 includes: a next live streaming start time calculation module configured to calculate the next start time based on the target end time and time information for the periodic live streaming in the first live streaming announcement.

In some embodiments, the apparatus 900 further includes: a database information acquisition module configured to acquire information of a database for storing announcement information for live streaming; and a live streaming announcement existence determination module configured to detect, based on the information, whether the first live streaming announcement for the periodic live streaming exists.

In some embodiments, the live streaming announcement existence determination module further includes: a periodic field information determination module configured to determine whether periodic field information exists in the information; and a first live streaming announcement detection module configured to determine that the first live streaming announcement for the periodic live streaming is detected in response to the presence of the periodic field information in the information.

In some embodiments, the apparatus 900 further includes: a live streaming announcement creation request module configured to receive, from the first device, a creation request for the first live streaming announcement for the periodic live streaming; a first live streaming announcement start determination module configured to determine a start time of the first live streaming announcement based on the creation request; and a first live streaming announcement storage module configured to store the first live streaming announcement including the start time into the database.

In some embodiments, the apparatus 900 further includes: a message generation module configured to generate a message based on the first live streaming announcement; and a message processing delay module configured to put the message into a delay message queue to delay processing of the message to the target end time.

In some embodiments, the apparatus 900 further includes a time arrival reminder module configured to remind a second device at a first time before a target start time arrives or remind the second device at a second time before the target start time arrives, the first time being different from the second time.

In some embodiments, the apparatus 900 further includes: a second live streaming announcement writing module configured to write the second live streaming announcement into the database; and a second live streaming announcement detection module configured to detect the second live streaming announcement by acquiring, from the database, information for the second live streaming announcement.

In some embodiments, the apparatus 900 further includes: a first time zone determination module configured to determine a first time zone where the first device is located in response to receiving a subscription request from a user; a standard time zone live streaming time determination module configured to determine a reference live streaming time of the periodic live streaming in a standard time zone based on the first time zone; and a live streaming announcement at user module configured to determine a live streaming announcement at the user based on the reference live streaming time and a second time zone where the user is located and which is included in the subscription request.

In some embodiments, the apparatus 900 further includes: a periodic live streaming end determination module configured to determine whether the periodic live streaming ends after a predetermined duration in response to determining that the periodic live streaming exists; and a third live streaming announcement generation module configured to generate a third live streaming announcement for the periodic live streaming in response to the end of the periodic live streaming.

FIG. 10 shows a schematic block diagram of an example device 1000 that may be used to implement the embodiments of the present disclosure. The computing device 102 in FIG. 1 may be implemented using the device 1000. As shown in the figure, the device 1000 includes a central processing unit (CPU) 1001, which may perform various appropriate actions and processes according to computer program instructions stored in a read-only memory (ROM) 1002 or computer program instructions loaded from a storage unit 1008 into a random access memory (RAM) 1003. In the RAM 1003, various programs and data required for operations of the device 1000 may also be stored. The CPU 1001, the ROM 1002 and the RAM 1003 are connected to each other through a bus 1004. An input/output (I/O) interface 1005 is also connected to the bus 1004.

Multiple components in the device 1000 are connected to the I/O interface 1005, and the components include: an input unit 1006, such as a keyboard, a mouse, etc.; an output unit 1007, such as various types of displays, speakers, etc.; a storage page 1008, such as a magnetic disk, an optical disc, etc.; and a communication unit 1009, such as a network card, a modem, a wireless communication transceiver, etc. The communication unit 1009 allows the device 1000 to exchange information/data with other devices over a computer network such as Internet and/or various telecommunication networks.

The various processes and treatments described above, such as the methods 200, 300 and the processes 400 and 500, may be executed by the processing unit 1001. For example, in some embodiments, the methods 200, 300 and the processes 400 and 500 may be implemented as computer software programs tangibly contained in a machine-readable medium, such as the storage unit 1008. In some embodiments, part or entirety of the computer program may be loaded and/or installed into the device 1000 via the ROM 1002 and/or the communication unit 1009. When the computer program is loaded into the RAM 1003 and executed by the CPU 1001, one or more actions of the example methods 200, 300 and the processes 400 and 500 described above may be implemented.

The present disclosure may be a method, an apparatus, a system, and/or a computer program product. The computer program product may include a computer-readable storage medium having computer-readable program instructions for performing various aspects of the present disclosure stored thereon.

The computer-readable storage medium may be a tangible device that may hold and store instructions used by an instruction execution device. The computer-readable storage medium may be, for example, but not limited to, an electrical storage device, a magnetic storage device, an optical storage device, an electromagnetic storage device, a semiconductor storage device, or any suitable combination of the foregoing. More specific examples (a non-exhaustive list) of the computer-readable storage medium include: a portable computer disk, a hard disk, a random access memory (RAM), a read-only memory (ROM), an erasable programmable read-only memory (EPROM or flash memory), a static random access memory (SRAM), a portable compact disk read-only memory (CD-ROM), a digital versatile disk (DVD), a memory stick, a floppy disk, a mechanically encoded device, such as a punch card or a raised structure in a groove having instructions stored thereon, and any suitable combination of the foregoing. The computer-readable storage medium used herein is not construed as an instantaneous signal itself, such as a radio wave or other freely propagating electromagnetic waves, electromagnetic waves propagating through a waveguide or other transmission media (for example, light pulses through an optical fiber cable), or electrical signals transmitted through wires.

The computer-readable program instructions described herein may be downloaded from the computer-readable storage medium to various computing/processing devices, or downloaded to an external computer or an external storage device through a network, such as Internet, a local area network, a wide area network, and/or a wireless network. The network may include a copper transmission cable, an optical fiber transmission, a wireless transmission, a router, a firewall, a switch, a gateway computer, and/or an edge server. A network adapter card or a network interface in each computing/processing device receives the computer-readable program instructions from the network and forwards the computer-readable program instructions for storage in a computer-readable storage medium in each computing/processing device.

The computer program instructions for performing the operations of the present disclosure may be assembly instructions, instruction set architecture (ISA) instructions, machine instructions, machine-related instructions, microcode, firmware instructions, state setting data, or source code or object code written in any combination of one or more programming languages, the programming languages including object-oriented programming languages, such as Smalltalk, C++, etc., and conventional procedural programming languages, such as "C" language or similar programming languages. The computer-readable program instructions may be executed entirely on a user computer, partly on the user computer, as a stand-alone software package, partly on the user computer and partly on a remote computer, or entirely on the remote computer or a server. In the case involving the remote computer, the remote computer may be connected to the user computer through any kind of network, including a local area network (LAN) or a wide area network (WAN), or it may be connected to an external computer (for example, connected by using Internet provided by an Internet service provider). In some embodiments, by using the state information of the computer-readable program instructions to customize an electronic circuit, such as a programmable logic circuit, a field programmable gate array (FPGA) or a programmable logic array (PLA), the electronic circuit may execute the computer-readable program instructions, thereby implementing various aspects of the present disclosure.

Various aspects of the present disclosure are described herein with reference to flowcharts and/or block diagrams of methods, apparatuses (systems) and computer program products according to embodiments of the present disclosure. It should be understood that each block of the flowcharts and/or block diagrams, and combinations of blocks in the flowcharts and/or block diagrams may be implemented by computer-readable program instructions.

These computer-readable program instructions may be provided to a processing unit of a general-purpose computer, a special-purpose computer, or other programmable data processing apparatus to produce a machine, such that these instructions, when executed by the processing unit of the computer or other programmable data processing apparatus, create apparatus for implementing a function/action specified in one or more blocks of the flowcharts and/or block diagrams. These computer-readable program instructions may also be stored in a computer-readable storage medium, these instructions cause the computer, the programmable data processing apparatus, and/or other devices to work in a specific manner, and thus, the computer-readable medium storing the instructions includes a manufactured product including instructions for implementing various aspects of the function/action specified in one or more blocks of the flowcharts and/or block diagrams.

The computer-readable program instructions may also be loaded onto a computer, other programmable data processing apparatus, or other devices, such that a series of operation steps are performed on the computer, other programmable data processing apparatus, or other devices to produce a computer-implemented process, thereby causing the instructions executed on the computer, other programmable data processing apparatus, or other devices to implement the function/action specified in one or more blocks of the flowcharts and/or block diagrams.

The flowcharts and block diagrams in the drawings show the possibly implemented architectures, functions, and operations of the systems, methods and computer program products according to multiple embodiments of the present disclosure. In this regard, each block in the flowchart or block diagram may represent a module, a program segment, or part of an instruction, which includes one or more executable instructions for implementing a specified logical function. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagrams and/or flowcharts, and combinations of the blocks in the block diagrams and/or flowcharts may be implemented by a special-purpose hardware-based system that perform a specified function or action, or may be implemented by a combination of special-purpose hardware and computer instructions.

The embodiments of the present disclosure have been described above, and the above description is exemplary, non-exhaustive, and not limited to the disclosed embodiments. Many modifications and variations will be apparent to those of ordinary skill in the art without departing from the scope and spirit of the described embodiments. The terms used herein are chosen to best explain the principles of the embodiments, the practical application or the technical improvement to the technology in the market, or to enable other those of ordinary skill in the art to understand the embodiments disclosed herein.

We claim:

1. A method for processing live streaming, comprising:
determining a first end time of a periodic live streaming in response to detecting a first live streaming announcement for the periodic live streaming;
determining whether the periodic live streaming is in a live streaming state in response to an arrival of the first end time;
determining a second start time of the periodic live streaming in response to determining that the periodic live streaming is not in the live streaming state; and
generating a second live streaming announcement for the periodic live streaming based on the second start time.

2. The method of claim 1, wherein determining the first end time of the periodic live streaming comprises:
determining a start time of the first live streaming announcement and a duration of the periodic live streaming based on the first live streaming announcement; and
determining the first end time based on the start time and the duration.

3. The method of claim 1, wherein determining the second start time of the periodic live streaming comprises:
calculating the second start time based on the first end time and time information for the periodic live streaming in the first live streaming announcement.

4. The method of claim 1, further comprising:
acquiring information of a database for storing announcement information for the live streaming; and
detecting, based on the information, whether the first live streaming announcement for the periodic live streaming exists.

5. The method of claim 4, wherein detecting whether the first live streaming announcement for the periodic live streaming exists comprises:
determining whether periodic field information exists in the information; and
determining that the first live streaming announcement for the periodic live streaming is detected in response to a presence of the periodic field information in the information.

6. The method of claim 4, further comprising:
receiving, from a first device, a creation request for the first live streaming announcement for the periodic live streaming;
determining a start time of the first live streaming announcement based on the creation request; and
storing the first live streaming announcement comprising the start time into the database.

7. The method of claim 4, further comprising:
generating a message based on the first live streaming announcement; and
putting the message into a delay message queue to delay processing of the message to the first end time.

8. The method of claim 7, further comprising performing at least one of:
reminding a second device at a first time before the first start time arrives; or
reminding the second device at a second time before the first start time arrives, the first time being different from the second time.

9. The method of claim 4, further comprising:
writing the second live streaming announcement into the database; and
detecting the second live streaming announcement by acquiring, from the database, information for the second live streaming announcement.

10. The method of claim 6, further comprising:
determining a first time zone wherein the first device is located in response to receiving a subscription request from a user;
determining a reference live streaming time of the periodic live streaming in a standard time zone based on the first time zone; and
determining a live streaming announcement at the user based on the reference live streaming time and a second time zone wherein the user is located and which is comprised in the subscription request.

11. The method of claim 1, further comprising:
determining whether the periodic live streaming ends after a predetermined duration in response to determining that the periodic live streaming is in a live streaming state; and
generating a third live streaming announcement for the periodic live streaming in response to an end of the periodic live streaming.

12. An electronic device, comprising:
at least one processor; and
a storage apparatus for storing at least one program, the at least one program, when executed by the at least one processor, causes the at least one processor to:
determine a first end time of a periodic live streaming in response to detecting a first live streaming announcement for the periodic live streaming;
determine whether the periodic live streaming is in a live streaming state in response to an arrival of the first end time;
determine a second start time of the periodic live streaming in response to determining absence of the periodic live streaming; and
generate a second live streaming announcement for the periodic live streaming based on the second start time.

13. The electronic device of claim 12, wherein the at least one program causing the at least one processor to determine the first end time of the periodic live streaming comprises instructions to:
determine a start time of the first live streaming announcement and a duration of the periodic live streaming based on the first live streaming announcement; and
determine the first end time based on the start time and the duration.

14. The electronic device of claim 12, wherein the at least one program causing the at least one processor to determine the second start time of the periodic live streaming comprises instructions to:
calculate the second start time based on the first end time and time information for the periodic live streaming in the first live streaming announcement.

15. The electronic device of claim 12, wherein the at least one program further comprises instructions to:
acquire information of a database for storing announcement information for the live streaming; and
detect, based on the information, whether the first live streaming announcement for the periodic live streaming exists.

16. The electronic device of claim 15, wherein the at least one program causing the at least one processor to detect whether the first live streaming announcement for the periodic live streaming exists comprises instructions to:
determine whether periodic field information exists in the information; and
determine that the first live streaming announcement for the periodic live streaming is detected in response to a presence of the periodic field information in the information.

17. The electronic device of claim 15, wherein the at least one program further comprises instructions to:
receive, from a first device, a creation request for the first live streaming announcement for the periodic live streaming;
determine a start time of the first live streaming announcement based on the creation request; and
store the first live streaming announcement comprising the start time into the database.

18. The electronic device of claim 15, wherein the at least one program further comprises instructions to:
generate a message based on the first live streaming announcement; and
put the message into a delay message queue to delay processing of the message to the first end time.

19. The electronic device of claim 18, wherein the at least one program further comprises at least one of instructions to:
remind a second device at a first time before the first start time arrives; or
remind the second device at a second time before the first start time arrives, the first time being different from the second time.

20. A non-transitory computer-readable storage medium having a computer program stored thereon, wherein the computer program, when executed by a processor, causes the processor to:
determine a first end time of a periodic live streaming in response to detecting a first live streaming announcement for the periodic live streaming;
determine whether the periodic live streaming is in a live streaming state in response to an arrival of the first end time;
determine a second start time of the periodic live streaming in response to determining absence of the periodic live streaming; and
generate a second live streaming announcement for the periodic live streaming based on the second start time.
